(19) United States
(12) Patent Application Publication
(10) Pub. No.: US 2023/0317367 A1
(43) Pub. Date: Oct. 5, 2023

(54) COIL

(71) Applicant: HONDA MOTOR CO., LTD., Tokyo (JP)

(72) Inventor: Jin Katsuya, Wako-shi (JP)

(21) Appl. No.: 18/125,163

(22) Filed: Mar. 23, 2023

(30) Foreign Application Priority Data
Mar. 29, 2022 (JP) 2022-054118

(51) Int. Cl. H01F 38/14; H01F 27/28

(52) U.S. Cl. CPC H01F 38/14; H01F 27/2823; H02J 50/10

(57) ABSTRACT

In a coil, a conducting wire is wound. A cross-section of the conducting wire is a rectangular shape having an aspect ratio of three or more. The conducting wire is arranged in a posture in which a longitudinal direction of the cross-section is along a central axis of the coil. A contactless power-receiving and supply system includes: a contactless power supply device including the coil; and a contactless power-receiving device including the coil.

### CROSS-REFERENCE TO RELATED APPLICATION

Priority is claimed on Japanese Pat. Application No. 2022-054118, filed on Mar. 29, 2022, the contents of which are incorporated herein by reference.

### BACKGROUND

### Field of the Invention

The present invention relates to a coil.

### Background

In recent years, in order to ensure easy access to affordable, reliable, sustainable, and advanced energy for more people, research and development have been conducted relating to charging power supply in vehicles in which secondary batteries are mounted and which contribute to energy efficiency.

Coils used for contactless power transmission systems are known (for example, refer to Japanese Unexamined Pat. Application, First Publication No. 2015-220357, Japanese Unexamined Pat. Application, First Publication No. 2010-042690, and Japanese Unexamined Utility Model Application, First Publication No. H06-050330).

### SUMMARY

In the technology relating to the charging power supply in the vehicles in which the secondary batteries are mounted, since the coil of the related art is made of a litz wire, it is difficult to perform end processing for electrically connecting a plurality of strands that constitute the litz wire to a terminal.

An object of an aspect of the present invention is to provide a coil that facilitates end processing. Further, the aspect of the present invention contributes to energy efficiency.

A first aspect of the present invention is a coil in which a conducting wire is wound, wherein a cross-section of the conducting wire is a rectangular shape having an aspect ratio of three or more, and the conducting wire is arranged in a posture in which a longitudinal direction of the cross-section is along a central axis of the coil.

According to this configuration, the cross-section of the conducting wire is defined as a rectangular shape having an aspect ratio of three or more. Thereby, since the end of the conducting wire can be a flattened shape, a peeling agent for peeling an insulation coating of the conducting wire made of a litz wire is not required, the coating of the conducting wire can be cut by mechanical contact from a short side direction of the cross-section having a rectangular shape, and it is possible to facilitate end processing. Compared to a coil in which a litz wire is wound, it is possible to reduce uneven distribution of a current density due to a proximity effect that occurs between adjacent strands, and it is possible to reduce alternating current resistance. Compared to a coil in which a straight angle conducting wire having a rectangular cross-section having an aspect ratio of about two is wound, which is used for an in-vehicle electric motor, it is possible to reduce uneven distribution of a current density inside the conducting wire due to a skin effect, and it is possible to reduce the alternating current resistance. The conducting wire is arranged in a posture in which the longitudinal direction of the cross-section is along the central axis of the coil. Thereby, it is possible to arrange the adjacent conducting wires at an appropriate distance and increase the number of turns while ensuring a cross-sectional area of the conducting wire in accordance with electric power distributed to the conducting wire. Accordingly, it is possible to enhance an occupation ratio of the conducting wire and enhance output, and the size of the coil in the direction along the central axis can be reduced. The surface area of the conducting wire can be increased, and it is possible to enhance cooling efficiency.

In a second aspect, the conducting wire may have a width of 0.45 mm or less.

According to this configuration, the conducting wire has a width of 0.45 mm or less. Thereby, since the end of the conducting wire can be a flattened shape, a peeling agent for peeling an insulation coating of the conducting wire is not required, the coating of the conducting wire can be cut by mechanical contact from a short side direction of the cross-section having a rectangular shape, and it is possible to facilitate end processing. It is possible to effectively reduce uneven distribution of a current density inside the conducting wire due to a skin effect, and it is possible to reduce the alternating current resistance.

In a third aspect, the conducting wire may be a twisted wire formed by twisting a first strand and a second strand.

According to this configuration, the conducting wire is a twisted wire formed by twisting the first strand and the second strand. Thereby, it is possible to reduce an opposing area between adjacent conducting wires that becomes a factor in increasing parasitic capacitance. Thereby, it is possible to adjust the height of the conducting wire while reducing the width of the conducting wire such that the parasitic capacitance that is generated in accordance with the opposing area and the capacitance of the resonance capacitor are almost the same value as each other. Accordingly, since the coil itself has a certain amount of capacitance component, a large number of serial capacitors to the extent of several tens of thousands of capacitors required for ensuring a withstand voltage corresponding to a large voltage generated at the coil end are not required in a circuit of a contactless power supply device or a circuit of a contactless power-receiving device, the number of required capacitors can be several, and magnetic field resonance can be obtained between a power supply coil and a power-receiving coil.

In a fourth aspect, surfaces of the first strand and the second strand that face each other in a direction perpendicular to the central axis may be in contact with each other.

According to this configuration, the surfaces of the first strand and the second strand that face each other in the direction perpendicular to the central axis are in contact with each other. Thereby, it is possible to reduce the size of the conducting wire in the direction perpendicular to the central axis. Accordingly, it is possible to enhance an occupation ratio of the coil and enhance output.

In a fifth aspect, the coil may be spirally wound along an identical plane.

According to this configuration, the coil is spirally wound along the identical plane. Thereby, the size of the coil in the direction along the central axis can be reduced. The parasitic capacitance and the leakage of electromagnetic waves can be reduced, and it is possible to ensure electromagnetic compatibility and output.

In a sixth aspect, the coil may be wound in a rectangular form along an identical plane.

According to this configuration, the coil is wound in a rectangular form along the identical plane. Thereby, it is possible to effectively ensure output while reducing the size of the coil in the direction along the central axis. By arranging a long side of the rectangular shape along a traveling direction of a vehicle in which a contactless power-receiving device is mounted, a transmission time of electric power can be ensured as long as possible even when a relative positional relationship between a coil of a contactless power supply device and a coil of the contactless power-receiving device that faces the contactless power supply device may deviate from each other.

A contactless power supply device according to a seventh aspect of the present invention includes the coil.

According to this configuration, the contactless power supply device includes the coil. Thereby, it is possible to decrease the size of the contactless power supply device in a direction along the central axis.

A contactless power-receiving device according to an eighth aspect of the present invention includes the coil.

According to this configuration, the contactless power-receiving device includes the coil. Thereby, it is possible to decrease the size of the contactless power-receiving device in a direction along the central axis.

A contactless power-receiving and supply system according to a ninth aspect of the present invention includes the contactless power supply device and the contactless power-receiving device.

According to this configuration, the contactless power-receiving and supply system includes the contactless power supply device and the contactless power-receiving device. Thereby, it is possible to effectively transmit electric power.

According to the aspect of the present invention, it is possible to provide a coil that facilitates end processing.

### BRIEF DESCRIPTION OF THE DRAWINGS

FIG. 1 is a perspective view showing a contactless power supply device or a contactless power-receiving device that includes a coil of a first embodiment.

FIG. 2A is a plan view of a conducting wire.

FIG. 2B is a cross-sectional view along arrow C in FIG. 2A.

FIG. 3 is a view showing a process of forming a conducting wire with a first strand.

FIG. 4 is a cross-sectional view of a coil according to a second embodiment.

FIG. 5 is a cross-sectional view of a coil according to a third embodiment.

### DESCRIPTION OF EMBODIMENTS

### First Embodiment

Hereinafter, a coil 1 according to a first embodiment of the present invention will be described with reference to the drawings.

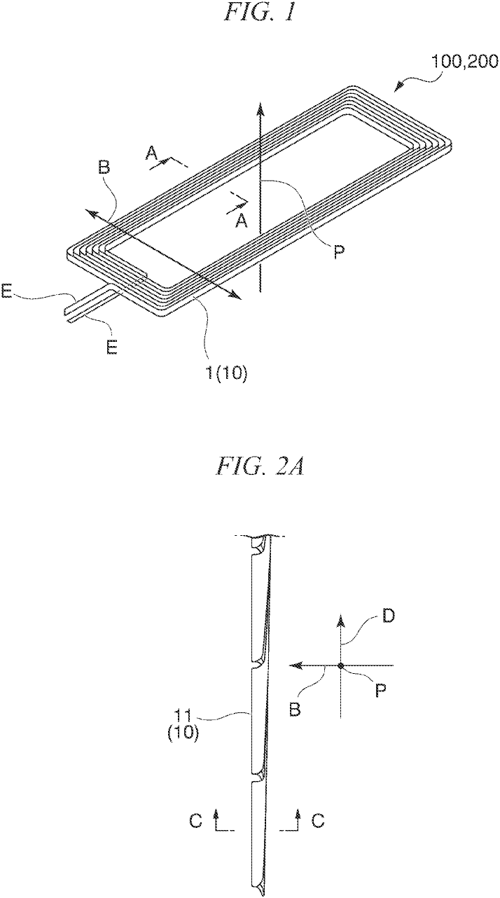

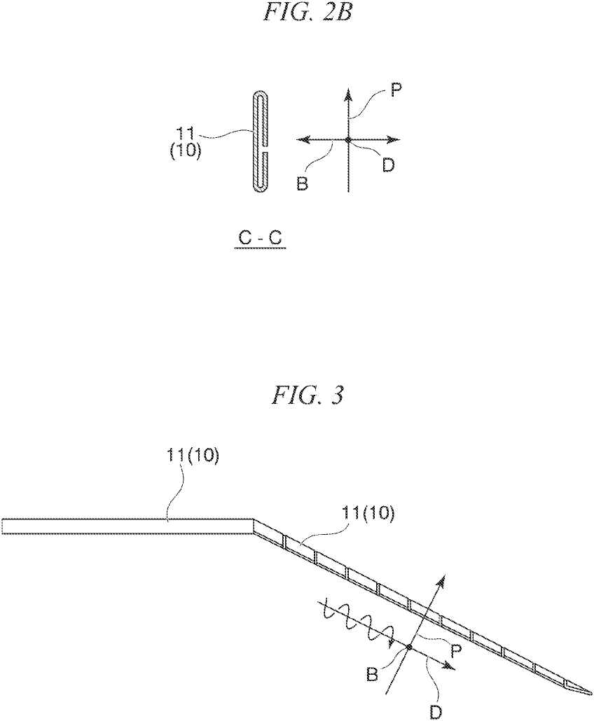

FIG. 1 is a perspective view showing a contactless power supply device 100 or a contactless power-receiving device 200 that includes the coil 1 of the first embodiment. FIG. 2A is a plan view of a conducting wire 10. FIG. 2B is a cross-sectional view along arrow C in FIG. 2A. FIG. 3 is a view showing a process of forming the conducting wire 10 with a first strand 11.

As shown in FIG. 1, the contactless power supply device 100 or the contactless power-receiving device 200 according to the first embodiment includes the coil 1 that is wound around a central axis P.

The coil 1 according to the first embodiment may be used in the contactless power supply device 100.

The contactless power supply device 100 that includes the coil 1 may be provided in the vicinity of a road surface of a road.

The coil 1 according to the first embodiment may be used in the contactless power-receiving device 200.

The contactless power-receiving device 200 that includes the coil 1 may be provided on a bottom portion of a vehicle that travels on a road.

The contactless power supply device 100 and the contactless power-receiving device 200 are provided in a contactless power-receiving and supply system arranged in a positional relationship in which the contactless power supply device 100 and the contactless power-receiving device 200 are able to be close to each other and face each other. The coil 1 may be used in the contactless power supply device 100. The coil 1 may be used in the contactless power-receiving device 200. The coil 1 may be used in both of the contactless power supply device 100 and the contactless power-receiving device 200.

The contactless power-receiving and supply system includes the contactless power supply device 100 including the coil 1 and the contactless power-receiving device 200 including the coil 1. The contactless power supply device 100 and the contactless power-receiving device 200 including the coil 1 are arranged in a positional relationship in which the contactless power supply device 100 and the contactless power-receiving device 200 face each other at a distance within an influence of magnetic field resonance. Thereby, electric power can be transmitted in a contactless manner (wirelessly) from the contactless power supply device 100 to the contactless power-receiving device 200.

### (Coil)

As shown in FIG. 1, the coil 1 has an end E at both ends. The end E is fixed to a terminal clasp by swaging and is soldered for reducing a contact resistance as appropriate. The coil 1 is obtained by winding the conducting wire 10. The conducting wire 10 is wound around the central axis P. The conducting wire 10 is wound, for example, seven turns around the central axis P.

A distance between adjacent conducting wires 10 (a distance between a center of an n-th turn conducting wire 10 and a center of an n+1-th turn conducting wire 10) can be preferably about twice the width of the conducting wire 10. Thereby, it is possible to reduce alternating current resistance.

The coil 1 can be preferably wound spirally along an identical plane. Thereby, the size of the coil 1 in a direction along the central axis P can be reduced. The parasitic capacitance and the leakage of electromagnetic waves can be reduced, and it is possible to ensure electromagnetic compatibility and output.

The coil 1 may be wound in a rectangular form along an identical plane. Thereby, it is possible to effectively ensure output while reducing the size of the coil in the direction along the central axis P. By arranging a long side of the rectangular shape along a traveling direction of a vehicle in which the contactless power-receiving device 200 is mounted, a transmission time of electric power can be ensured as long as possible even when a relative positional relationship between the coil 1 of the contactless power supply device 100 and the coil 1 of the contactless power-receiving device 200 that faces the contactless power supply device 100 may deviate from each other.

### (Conducting Wire)

The conducting wire 10 is formed of, for example, a conductive material such as copper, aluminum, or clad steel.

The conducting wire 10 is coated by an insulation coating made of a resin material or the like that can be melted at a soldering temperature.

The cross-section of the conducting wire 10 is a rectangular shape having an aspect ratio of three or more. In the cross-section of the conducting wire 10, for example, the full width which is a size in a direction B perpendicular to the central axis P is between 0.16 mm and 0.90 mm. The height which is a size in a direction along the central axis P is 16 mm. Accordingly, in the case of this example, the aspect ratio is approximately more than 17 and equal to or less than 100.

Thereby, since the end of the conducting wire 10 can be a flattened shape, a peeling agent for peeling an insulation coating of the conducting wire made of a litz wire is not required, the coating of the conducting wire 10 can be cut by mechanical contact (for example, cutting by contacting a sharp edge formed on a blade member having high hardness) from a short side direction of the cross-section having a rectangular shape, and it is possible to facilitate end processing. Compared to a coil in which a litz wire is wound, it is possible to reduce uneven distribution of a current density due to a proximity effect that occurs between adjacent strands, and it is possible to reduce alternating current resistance. Compared to a coil in which a straight angle conducting wire having a rectangular cross-section having an aspect ratio of about two is wound, which is used for an in-vehicle electric motor, it is possible to reduce uneven distribution of a current density inside the conducting wire due to a skin effect, and it is possible to reduce the alternating current resistance.

As shown in FIG. 2A and FIG. 2B, the conducting wire 10 is arranged in a posture in which the longitudinal direction of the cross-section perpendicular to an extension direction D is along the central axis P of the coil 1. Thereby, it is possible to arrange the adjacent conducting wires 10 at an appropriate distance and increase the number of turns while ensuring a cross-sectional area of the conducting wire 10 in accordance with electric power distributed to the conducting wire 10. Accordingly, it is possible to enhance an occupation ratio of the conducting wire and enhance output, and the size of the coil in the direction along the central axis P can be reduced. The surface area of the conducting wire 10 can be increased, and it is possible to enhance cooling efficiency.

The conducting wire 10 can preferably have a width of 0.45 mm or less. Thereby, since the end of the conducting wire 10 can be a flattened shape, a peeling agent for peeling an insulation coating of the conducting wire 10 is not required, the coating of the conducting wire 10 can be cut by mechanical contact from a short side direction (width direction) of the cross-section having a rectangular shape, and it is possible to facilitate end processing. Thereby, the width of the conducting wire 10 can be within twice a skin depth δ of the conducting wire 10 in a case where a use frequency is equal to or more than 85 kHz which is used in a contactless power-receiving and supply system. The skin depth δ may be a theoretical value calculated from an angular frequency of an alternating current flowing through the conducting wire 10, electrical conductivity of the conducting wire 10, and magnetic permeability of the conducting wire 10. Accordingly, even in a case where the skin depth δ is small and the use frequency is a relatively high frequency at which electric conduction is difficult to be made inside the conducting wire 10, it is possible to facilitate conduction in an entire region of the cross-section of the conducting wire 10. It is possible to effectively reduce uneven distribution of a current density inside the conducting wire due to the skin effect or the proximity effect, and it is possible to reduce alternating current resistance.

As shown in FIG. 2A, FIG. 2B, and FIG. 3, the conducting wire 10 is obtained by forming a single body of the first strand 11 in a spiral form.

The first strand 11 may be obtained by forming a band body that has cross-sections having the same thickness and the same width and linearly extends in a spiral form.

As shown in FIG. 3, for example, by spirally winding the first strand 11, which is the band body that has cross-sections having the same thickness and the same width and linearly extends, with a Z winding around the extension direction D of the conducting wire 10 as shown by a spiral arrow and then compressing the first strand 11 in a direction B perpendicular to the central axis P, the conducting wire 10 can be formed in a plan view shown in FIG. 2A and in a cross-section shown in FIG. 2B. The first strand 11 can preferably have a thickness of 0.45 mm or less. Thereby, the thickness of the first strand 11 can be within twice the skin depth δ where a high-frequency current easily flows, and it is possible to reduce alternating current resistance. An outer surface of the first strand 11 is covered with an insulation coating.

In this way, the conducting wire 10 is obtained by forming the first strand 11 in a spiral form. Thereby, it is possible to reduce an opposing area between adjacent conducting wires 10 that becomes a factor of increasing parasitic capacitance. It is possible to adjust the height of the conducting wire 10 while reducing the width of the conducting wire 10 such that the parasitic capacitance that is generated in accordance with the opposing area and the capacitance of the resonance capacitor are almost the same value as each other. Accordingly, a large number of capacitors are not required in the circuit of the contactless power supply device 100 or the circuit of the contactless power-receiving device 200, and magnetic field resonance can be obtained between a power supply coil and a power-receiving coil.

Surfaces (inner surfaces of the spiral) of the first strand 11 that face each other in the direction B perpendicular to the central axis P can be preferably in contact with each other. The first strand 11 has a flattened shape formed to be collapsed in one direction (the direction B perpendicular to the extension direction D and the central axis P) in a state where the first strand 11 is wound in a spiral form along the extension direction D. Inner surfaces of the spiral of the first strand 11 can be preferably in close contact with each other. That is, it is preferable that the inside of the conducting wire 10 not form a cavity. Thereby, it is possible to reduce the size of the conducting wire 10 in the direction B perpendicular to the central axis P. Accordingly, it is possible to enhance an occupation ratio of the coil 1 and enhance output.

### Second Embodiment

Next, a coil 2 according to a second embodiment of the present invention will be described with reference to the drawings. The same number or the same reference sign is given to portions having a common function of the coil 2 according to the second embodiment and the coil 1 according to the first embodiment. In some cases, the explanation of the portions having a common function of the coil 2 according to the second embodiment and the coil 1 according to the first embodiment may be omitted.

FIG. 4 is a cross-sectional view of the coil 2 according to the second embodiment.

As shown in FIG. 4, the coil 2 according to the second embodiment is obtained by winding the conducting wire 10 similarly to the coil 1 according to the first embodiment. Similarly, the cross-section of the conducting wire 10 is a rectangular shape having an aspect ratio of three or more (here about 36). Similarly, the conducting wire 10 is arranged in a posture in which the longitudinal direction of the cross-section is along the central axis P of the coil 2.

Here, the conducting wire 10 has a width of 0.45 mm or less.

Further, the conducting wire 10 of the coil 2 according to the second embodiment is not a twisted wire formed by twisting the first strand 11 and the second strand 12, but a single wire of the first strand 11.

The first strand 11 that constitutes the conducting wire 10 of the coil 2 according to the second embodiment is a band body that has a cross-section of a flattened shape and extends along the extension direction D of the conducting wire 10. The first strand 11 that constitutes the conducting wire 10 of the coil 2 according to the second embodiment is not twisted. That is, the conducting wire 10 is not one twisted wire (a single twisted wire) formed by twisting a single wire of the first strand 11.

In this way, the conducting wire 10 of the coil 2 according to the second embodiment is a single wire having a foil form. Thereby, since the end of the conducting wire 10 can be a flattened shape, it is possible to facilitate end processing. It is possible to effectively reduce uneven distribution of a current density inside the conducting wire due to a skin effect, and it is possible to reduce alternating current resistance.

### Third Embodiment

Next, a coil 3 according to a third embodiment of the present invention will be described with reference to the drawings. The same number or the same reference sign is given to portions having a common function of the coil 3 according to the third embodiment, and the coil 1 according to the first embodiment or the coil 2 according to the second embodiment. In some cases, the explanation of the portions having a common function of the coil 3 according to the third embodiment, and the coil 1 according to the first embodiment or the coil 2 according to the second embodiment may be omitted.

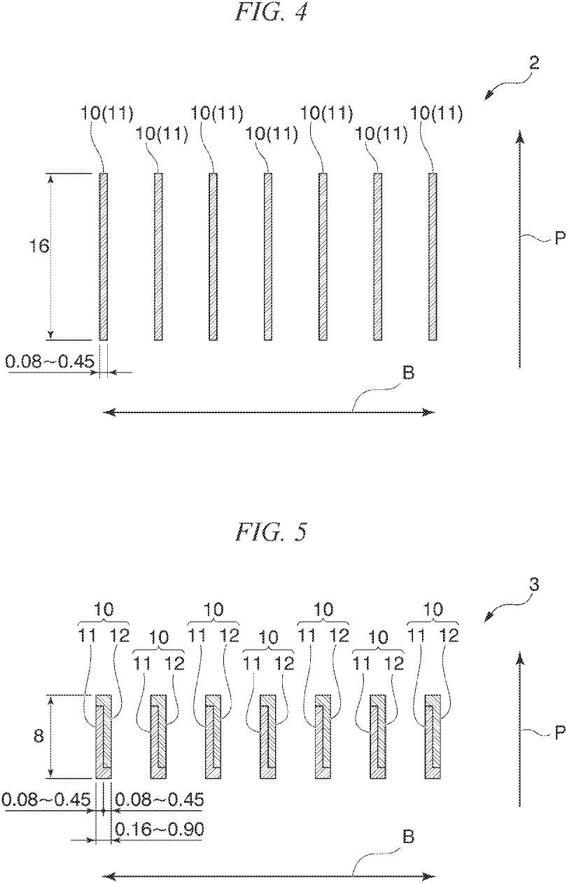

FIG. 5 is a cross-sectional view of the coil 3 according to the third embodiment.

As shown in FIG. 5, the coil 3 according to the third embodiment is obtained by winding the conducting wire 10 similarly to the coil 1 according to the first embodiment or the coil 2 according to the second embodiment. Similarly, the cross-section of the conducting wire 10 is a rectangular shape having an aspect ratio of three or more (here about 18). Similarly, the conducting wire 10 is arranged in a posture in which the longitudinal direction of the cross-section is along the central axis P of the coil 3.

The conducting wire 10 of the coil 3 according to the third embodiment is a twisted wire formed by twisting the first strand 11 and the second strand 12.

The conducting wire 10 of the coil 3 according to the third embodiment is a twisted wire in which the first strand 11 having a width of 0.08 mm or more and 0.45 mm or less and the second strand 12 having the same size as the first strand 11 are overlapped with each other by a double twist. Accordingly, the conducting wire 10 of the coil 3 has an entire width of 0.16 mm or more and 0.90 mm or less.

Here, the conducting wire 10 of the coil 3 according to the third embodiment has a height of 8 mm. The cross-section of the conducting wire 10 of the coil 3 according to the third embodiment has an aspect ratio of 3 or more and 18 or less.

Thereby, since the end of the conducting wire 10 can be a flattened shape, it is possible to facilitate end processing. While reducing the area of opposing surface of adjacent conducting wires 10 in the direction B perpendicular to the central axis P and reducing parasitic capacitance, it is possible to effectively reduce uneven distribution of a current density inside the conducting wire due to a skin effect or a proximity effect, and it is possible to reduce alternating current resistance.

As shown in FIG. 5, each of the first strand 11 and the second strand 12 may be a band body that has cross-sections having the same thickness and the same width and linearly extends. The first strand 11 or the second strand 12 can preferably have a thickness of 0.45 mm or less. Thereby, the thickness of the first strand 11 or the second strand 12 can be within twice the skin depth δ where a high-frequency current easily flows, and it is possible to reduce alternating current resistance. The first strand 11 and the second strand 12 may have the same size. Each of outer surfaces of the first strand 11 and the second strand 12 is covered with an insulation coating. Accordingly, in the conducting wire 10, the first strand 11 and the second strand 12 are insulated from each other.

The first strand 11 is spirally twisted with a S twist along the extension direction D of the conducting wire 10. Similarly, the second strand 12 is spirally twisted with the S twist along the extension direction D of the conducting wire 10 indicated by a white arrow. The first strand 11 and the second strand 12 may be twisted with a Z twist. The first strand 11 and the second strand 12 are twisted so as to be alternately arranged along the extension direction D of the conducting wire 10. The first strand 11 and the second strand 12 have a so-called double twisted wire structure. The conducting wire 10 is not limited to the double twisted wire structure. The conducting wire 10 may include a third strand in addition to the first strand 11 and the second strand 12 and may have a multiple twisted wire structure such as a triple twisted wire structure or more.

When the conducting wire 10 is a multiple twisted wire having the first strand 11 and the second strand 12, surfaces of the first strand 11 and the second strand 12 that face each other in a direction B perpendicular to the central axis P can be preferably in contact with each other. The first strand 11 and the second strand 12 have a flattened shape formed to be collapsed in one direction (the direction B perpendicular to the extension direction D and the central axis P) in a multiple twist state where each of the first strand 11 and the second strand 12 is twisted and alternately arranged. Inner surfaces of the first strand 11 and the second strand 12 are in close contact with each other. That is, in the inside of the conducting wire 10, a cavity is not formed between the first strand 11 and the second strand 12. Thereby, it is possible to reduce the size of the conducting wire 10 in the direction B perpendicular to the central axis P. Accordingly, it is possible to enhance an occupation ratio of the coil 3 and enhance output.

The technical scope of the present invention is not limited to the embodiments described above, and various modifications can be made without departing from the scope of the present invention.

It is possible to appropriately replace the constituent elements in the embodiments described above with known constituent elements without departing from the scope of the present invention, and the modification examples described above may be combined as appropriate.

What is claimed is:

1. A coil in which a conducting wire is wound,
wherein a cross-section of the conducting wire is a rectangular shape having an aspect ratio of three or more, and
the conducting wire is arranged in a posture in which a longitudinal direction of the cross-section is along a central axis of the coil.

2. The coil according to claim 1,
wherein the conducting wire has a width of 0.45 mm or less.

3. The coil according to claim 1,
wherein the conducting wire is a twisted wire formed by twisting a first strand and a second strand.

4. The coil according to claim 3,
wherein surfaces of the first strand and the second strand that face each other in a direction perpendicular to the central axis are in contact with each other.

5. The coil according to claim 1,
wherein the coil is spirally wound along an identical plane.

6. The coil according to claim 1,
wherein the coil is wound in a rectangular form along an identical plane.

7. A contactless power supply device, comprising:
the coil according to claim 1.

8. A contactless power-receiving device, comprising:
the coil according to claim 1.

9. A contactless power-receiving and supply system, comprising:
the contactless power supply device according to claim 7; and
the contactless power-receiving device according to claim 8.
